(19) United States
(12) Patent Application Publication
(10) Pub. No.: US 2018/0175929 A1
(43) Pub. Date: Jun. 21, 2018

(54) METHOD, APPARATUS, AND SYSTEM FOR D2D RELAY

(71) Applicant: Alcatel Lucent, Nozay (FR)

(72) Inventors: Zhi Wang, Shanghai (CN); Yigang Cai, Naperville, NJ (US)

(73) Assignee: Alcatel Lucent, Nozay (FR)

(21) Appl. No.: 15/735,386

(22) PCT Filed: May 11, 2016
(86) PCT No.: PCT/IB2016/000769

§ 371 Date: Dec. 11, 2017

(30) Foreign Application Priority Data
Jun. 11, 2015 (CN) 201510319739.3

(51) Int. Cl. H04B 7/14; H04W 76/14; H04W 68/02; H04W 64/00; H04W 8/02; H04W 76/30

(52) U.S. Cl. CPC H04B 7/14; H04W 76/14; H04W 68/02; H04W 88/04; H04W 8/02; H04W 76/30; H04W 64/00

(57) ABSTRACT

An object of the invention is providing method, apparatus, and System for D2D Relay. Compared with the prior art, the present invention attaches/detaches a user equipment to/from a mobility management entity through a relay device, thereby implementing a brand new procedure and function of policy and service control for D2D Relay scenarios. Through the signaling communication with major network, instead, under the control by the relay device, which would save radio resource and limited resource on constrained UEs; the present invention also enables a policy/service control for the user equipment, and enables that the service can be relayed through the relay device; the present invention may also save much resource on the network for maintaining the bearer and signaling path for the user equipment without any service impact; besides, the present invention also proposes a solution for the traffic congestion between eNB and MME caused by group message broadcasting.

### FIELD OF THE INVENTION

The present invention relates to the field of telecommunication, and in particular to the technology of D2D Relay.

### BACKGROUND OF THE INVENTATION

Device-to-Device (D2D) communication has been highly recognized as an efficient way to improve system performance for future wireless networks. A large number of research works and projects on D2D systems focus on one-hop (i.e. one D2D pair) communication. On the other hand, multi-hop communications arise in many emerging applications, such as data communication in hotspots. The corresponding research of multi-hop communications is highly associated with specific applications, such as mobile social networks for advertisement push, and community networks for fast data dissemination. At present, Device to Device communication is also viewed as one of key evolutionary technologies for 5G.

However, existing D2D Relay solution only support IP packets relay, it is not good enough since there is no signaling communication supported in existing D2D Relay solution, signaling communication (such as SMS, Machine type communication (MTC) carried by SMS, etc.) cannot reach the remote UE (i.e. the UE which connects to the network through D2D relay UE), therefore, this solution does not support policy and service control for the remote UE. To support the policy and service control from major network (e.g. EPC, etc.) in D2D relay scenarios, one possible solution is to make the remote UE to maintain the signaling communication with major network besides relaying the IP packet through D2D Relay capable UE. Obviously, this is inefficient on radio resource and limits the network capacity. Besides, this solution also does not work in the scenario that the remote UE is out of the coverage of major network. Therefore, how to reduce the signaling connections between the remote UE and network is a significant requirement in 5G study.

### SUMMARY OF THE INVENTION

An object of the invention is providing method, apparatus, and system for D2D Relay.

According to one aspect of the invention, a method for D2D relay is provided, wherein the method comprises:

obtaining, by a base station, an attach request/detach request transmitted by a relay device, wherein the attach request/detach request includes identification information of the relay device, and identification information of one or more user equipments corresponding to the attach request/detach request;

forwarding, by the base station, the attach request/detach request to a mobility management entity corresponding to the base station;

updating, by the mobility management entity, location information corresponding to the user equipment;

transmitting, by the mobility management entity, an attach acceptance message/detach acceptance message to the base station, wherein the attach acceptance message corresponds to the attach request, the detach acceptance message corresponds to the detach request;

transmitting, by the base station, the attach acceptance message/detach acceptance message to the relay device, such that the relay device forwards the attach acceptance message/detach acceptance message to the user equipment.

According to another aspect of the invention, a base station for D2D relay is further provided, wherein the base station comprises:

a first request obtaining module configured to obtain an attach request/detach request transmitted by a relay device, wherein the attach request/detach request includes identification information of the relay device, and identification information of one or more user equipments corresponding to the attach request/detach request;

a first request transmitting module configured to forward the attach request/detach request to a mobility management entity corresponding to the base station;

wherein the base station further comprises:

a first acceptance obtaining module configured to obtain an attach acceptance message/detach acceptance message transmitted by the mobility management entity, wherein the attach acceptance message corresponds to the attach request, the detach acceptance message corresponds to the detach request;

a first acceptance transmitting module configured to transmit the attach acceptance message/detach acceptance message to the relay device, such that the relay device forwards the attach acceptance message/detach acceptance message to the user equipment.

According to another aspect of the invention, a mobility management entity for D2D relay is further provided, wherein the mobility management entity comprises:

a second request obtaining module configured to obtain an attach request/detach request transmitted by a base station corresponding to the mobility management entity, wherein the attach request/detach request includes identification information of the relay device, and identification information of one or more user equipments corresponding to the attach request/detach request;

a location updating module configured to update location information corresponding to the user equipment;

wherein the mobility management entity further comprises:

a second acceptance transmitting module configured to transmit an attach acceptance message/detach acceptance message to the base station, wherein the attach acceptance message corresponds to the attach request, the detach acceptance message corresponds to the detach request.

According to another aspect of the invention, a policy management device for D2D relay is further provided, wherein the device comprises:

a notification obtaining module configured to obtain a change notification message transmitted by a mobility management entity corresponding to the policy management device, wherein the change notification message includes attach status information of the user equipment and the identification information of the user equipment;

a policy determining module configured to determine policy information associated with the user equipment based on the change notification message.

According to another aspect of the invention, a system for D2D relay is further provided, wherein the system comprises the base station as aforesaid, the mobility management entity as aforesaid, and the policy management device as aforesaid.

Compared with the prior art, the present invention attaches/detaches a user equipment to/from a mobility management entity through a relay device, thereby implementing a brand new procedure and function of policy and service control for D2D Relay scenarios, and has the following advantages:

1) With this invention, the user equipment (i.e. remote UE) does not to maintain the signaling communication with major network (e.g. LTE/EPC) besides relaying the IP packets through the relay device, instead, under the control by a relay device, which would save radio resource and limited resource on constrained UEs. Moreover, the present invention also provides high capacity for wireless network.

2) Besides enabling the signaling communication with major network, the present invention also enables the policy/service control for the user equipment, the user equipment specific services can apply to the bearer and data flow of it. The present invention also enables the IP services/rouging base on service chaining/GiLAN(i.e., a service zone between the S/PGW and Internet)/SDN, etc . . . .

3) The present invention enables service like SMS, Machine type communication through SMS, etc . . . could be relayed through the relay device.

4) The present invention would save much resource on the network for maintaining the bearer and signaling path for the user equipment. If a user equipment has direct communication with the relay device, related resource can be saved without any service impact.

5) The present invention also proposes a solution for the traffic congestion between eNB and MME caused by group message broadcasting. If a message is sent to a group by an application, the message and its response can be relayed through the relay device, it eliminates traffic congestion between eNB and MME caused by group message broadcasting.

6) The present invention provides a key solution to 5G study on reducing the signaling connection.

### BRIEF DESCRIPTION OF THE DRAWINGS

Other features, purposes and advantages of the invention will become more explicit by means of reading the detailed statement of the non-restrictive embodiments made with reference to the accompanying drawings.

FIG. 1 shows a schematic diagram of a communication system architecture for D2D relay according to one aspect of the present invention;

FIG. 2 shows a schematic diagram of a base station and a mobility management entity for D2D relay according to one aspect of the present invention;

FIG. 3 shows a schematic diagram of a base station, a mobility management entity and a policy management device for D2D relay according to one preferred embodiment of the present invention;

FIG. 4 shows a flow diagram of a method for D2D relay by cooperation of a base station and a mobility management entity according to another aspect of the present invention;

FIG. 5 shows a flow diagram of a method for D2D relay by cooperation of a base station, a mobility management entity and a policy management device according to one preferred embodiment of the present invention;

FIG. 6 shows a flow diagram of an attach method for D2D relay according to one preferred embodiment of the present invention;

FIG. 7 shows a flow diagram of a detach method for D2D relay according to one preferred embodiment of the present invention;

FIG. 8 shows a flow diagram of a method for a mobile terminating short messaging service for a remote UE using D2D relay according to one preferred embodiment of the present invention.

The same or similar reference signs in the drawings represent the same or similar component parts.

### DETAILED DESCRIPTION OF THE INVENTION

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figures. The processes may correspond to methods, functions, procedures, subroutines, subprograms, etc.

As used herein, the term “user equipment” may be considered synonymous to, and may hereafter be occasionally referred to, as a client, mobile user, mobile station, subscriber, user, remote station, access terminal, receiver, mobile unit, etc., and may describe a remote user, remote UE or remote terminal of wireless resources in a wireless communication network.

Similarly, as used herein, the term “base station” may be considered synonymous to, and may hereafter be occasionally referred to, as a Node B, evolved Node B, eNodeB, Base Transceiver Station (BTS), Radio Network Controller (RNC), etc., and may describe a transceiver in communication with and providing wireless resources to mobiles in a wireless communication network which may span multiple technology generations. As discussed herein, base stations may have all functionality associated with conventional, well-known base stations in addition to the capability to perform the methods discussed herein.

Similarly, as used herein, the term “mobility management entity” may be considered as an MME in the LTE system architecture or other device capable of implementing functions of a mobility management entity; the term “policy management device” as used may be considered as a PCRF (Policy and Charging Rules Function) in the LTE system or other network device or user device that has information transceiving and processing functionality and can implement policy management.

Specific structural and functional details disclosed herein are merely representative for purposes of describing example embodiments of the present invention. This invention may, however, be embodied in many alternate forms and should not be construed as limited to only the embodiments set forth herein.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Below, details of the invention will be further provided in combination with the accompanying drawings.

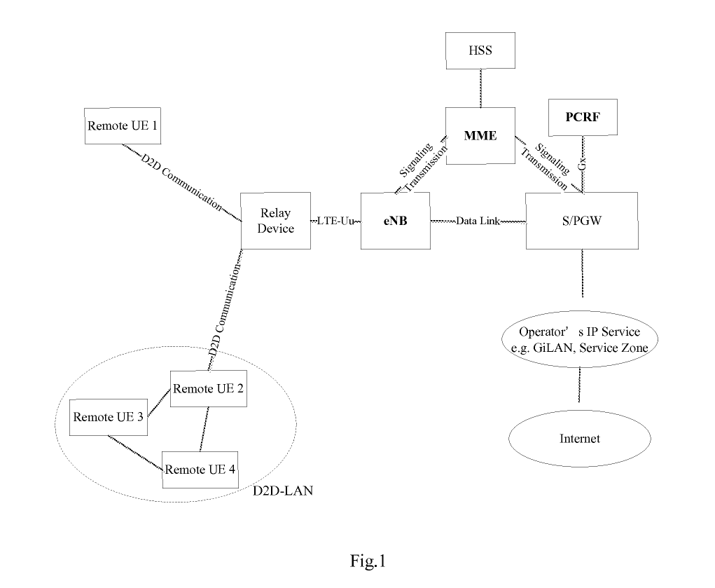

FIG. 1 shows a schematic diagram of a communication system architecture for D2D relay according to one aspect of the present invention. Through the communication system architecture as shown in FIG. 1, a policy and service control for D2D relay is implemented.

The relay device is connected to a single remote UE (e.g., remote UE1) or multiple remote UEs (e.g., remote UE2, remote UE3, and remote UE4) through a D2D communication manner. Here, the multiple remote UEs may form a D2D-LAN, so as to communicate with the relay UE through a shared D2D communication connection. The relay UE may provide UE-to-Network relay for single UE or D2D-LAN through D2D communication.

On the other hand, the relay device is connected to the eNB via an LTE-Uu interface, the eNB, MME and PCRF are enhanced to support the new attach/detach procedure and further policy and service control for remote UE.

In the communication system architecture as shown in FIG. 1, signaling communication is established between the eNB and the MME, and signaling communication is also established between the MME and the SGW/PGW; besides, data link communication is established between the eNB and the SGW/PGW. In the attach/detach procedures of the remote UE, once the remote UE is connected to the network through a relay device, attach/detach is performed to the remote UE based on the signaling communication between the eNB and the MME and the signaling communication between the MME and the SGW/PGW.

Here, those skilled in the art should understand that it is not for limiting the present invention with the LTE system in FIG. 1 as an example. The architecture diagram and the specific devices in the architecture diagram are only examples, and other device applicable to the architecture or other architecture suitable for the present invention should be included within the protection scope of the present invention and is incorporated here by reference.

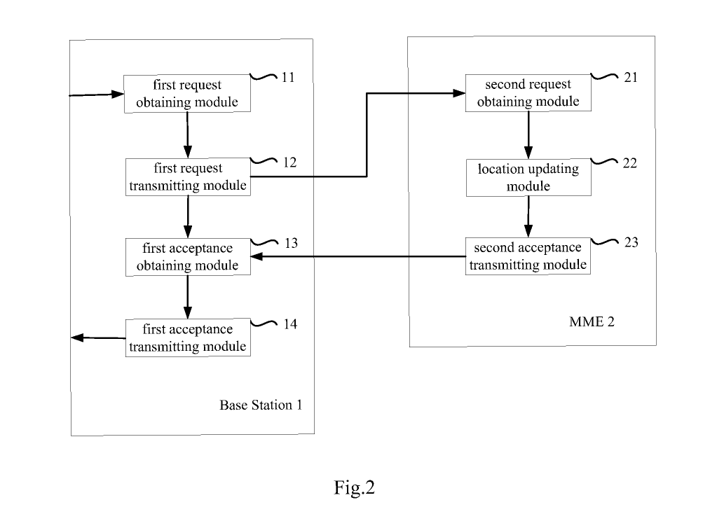

FIG. 2 shows a schematic diagram of a base station and a mobility management entity for D2D relay according to one aspect of the present invention; wherein, the base station 1 comprises a first request obtaining module 11, a first request transmitting module 12, a first acceptance obtaining module 13, a first acceptance transmitting module 14; the mobility management entity 2 comprises a second request obtaining module 21, a location updating module 22, a second acceptance transmitting module 23.

Specifically, the first request obtaining module 11 obtains an attach request/detach request transmitted by a relay device, wherein the attach request/detach request includes identification information of the relay device, and identification information of one or more user equipments corresponding to the attach request/detach request; the first request transmitting module 12 forwards the attach request/detach request to a mobility management entity corresponding to the base station; correspondingly, the second request obtaining module 21 obtains the attach request/detach request transmitted by the base station corresponding to the mobility management entity, wherein the attach request/detach request includes identification information of the relay device, and identification information of one or more user equipments corresponding to the attach request/detach request; the location updating module 22 updates location information corresponding to the user equipment; the second acceptance transmitting module 23 transmits an attach acceptance message/detach acceptance message to the base station, wherein the attach acceptance message corresponds to the attach request, the detach acceptance message corresponds to the detach request; correspondingly, the first acceptance obtaining module 13 obtains the attach acceptance message/detach acceptance message transmitted by the mobility management entity, wherein the attach acceptance message corresponds to the attach request, the detach acceptance message corresponds to the detach request; the first acceptance transmitting module 14 transmits the attach acceptance message/detach acceptance message to the relay device, such that the relay device forwards the attach acceptance message/detach acceptance message to the user equipment.

Here, the base station and the mobility management entity may perform an attach procedure to the user equipment first through the D2D relay, and then perform a detach procedure to the user equipment; they may also perform a detach procedure to the attached user equipment directly through the D2D relay, without considering whether the attach procedure of the user equipment has gone through the D2D relay.

Hereinafter, explanations will be illustrated through an attach procedure and a detach procedure respectively:

In the attach procedure:

The first request obtaining module 11 obtains an attach request transmitted by a relay device, wherein the attach request includes identification information of the relay device, and identification information of one or more user equipments corresponding to the attach request.

Specifically, the user equipment may initiatively transmit a request to the relay device so as to obtain identification information of the relay device which is transmitted by the relay device; or, the relay device may initiatively notify its identification information to the user equipment. Therefore, the user equipment may generate an attach request including the identification information of the user equipment and the identification information of the relay device, and transmit the attach request to the relay device; then, the relay device forwards the attach request to a base station.

Or, the user equipment may establish a correspondence relationship with the relay device through a registration procedure; then, the user equipment transmits an attach request including the identification information of the user equipment to the relay device; the relay device, after adding its own identification information to the attach request, sends the attach request to the base station.

Here, the identification information of the user equipment or the identification information of the relay device includes, but not limited to, various kinds of identification codes such as IMSI.

Here, if the attach request or detach request corresponds to a plurality of user equipments, then the plurality of user equipments may transmit the user identification information to the relay device, respectively; a D2D-LAN may also be formed, where a plurality of user equipments share the same D2D-LAN identification information; through the replay device's processing to the D2D-LAN identification information, processing of the plurality of user equipments is realized.

The first request transmitting module 12 forwards the attach request to a mobility management entity corresponding to the base station; correspondingly, the second request obtaining module 21 obtains the attach request transmitted by the base station corresponding to the mobility management entity, wherein the attach request includes identification information of the relay device, and identification information of one or more user equipments corresponding to the attach request.

Specifically, the first request transmitting module 12 identifies that the attach request is a D2D relay attach request based on the identification information of the relay device in the attach request; and forwards the attach request to the mobility management entity corresponding to the base station. Since the user equipment will share the bearer with the relay device, bearer creation operation will be ignored in the attach procedure.

The location updating module 22 updates location information corresponding to the user equipment.

Specifically, the location updating module 22 updates the location information of the user equipment to location information corresponding to the current mobility management entity based on the attach request.

Preferably, the mobility management entity 2 further comprises a session deleting module (not shown); if an initial session exists between the user equipment and an initial mobility management entity, then the session deleting module will delete the initial session such that the location updating module 22 updates the location information of the user equipment from the initial mobility management entity to the current mobility management entity.

Preferably, the mobility management entity 2 further comprises a mapping updating module (not shown); the mapping updating module updates, based on the attach request, a mapping relationship between identification information of the relay device and identification information of the user equipment.

Specifically, in the attach procedure, if the user equipment does not establish a mapping with any relay device, then the updating operation is a storing operation; if the user equipment has established a mapping with other relay device, then the original mapping is deleted, and the current mapping is stored for further signaling communication routing and the policy and service control.

The second acceptance transmitting module 23 transmits an attach acceptance message to the base station, wherein the attach acceptance message corresponds to the attach request. Correspondingly, the first acceptance obtaining module 13 obtains the attach acceptance message transmitted by the mobility management entity.

Specifically, when all of the above relevant processes are completed, the second acceptance transmitting module 23 will transmit an attach acceptance message corresponding to the attach request to the base station, the attach acceptance message indicates that the attach request has been accepted.

The first acceptance transmitting module 14 transmits the attach acceptance message to the relay device, such that the relay device forwards the attach acceptance message to the user equipment.

Preferably, after the attach procedure is completed, a device such as the mobility management entity may also process various kinds of paging messages to the user equipment, e.g., a short messaging service message (SMS), etc.

The mobility management entity comprises a first module (not shown), a second module (not shown), a third module (not shown), a fourth module (not shown), and a fifth module (not shown). Specifically, the first module obtains one or more paging messages to the user equipment which are transmitted by a paging request device, wherein the paging message includes identification information of the user equipment; the second module transmits a paging request and a service request to the relay device corresponding to the user equipment based on identification information of the user equipment; the third module transmits the service request to the paging request device; the fourth module obtains a data message transmitted by the paging request device, wherein the data message corresponds to the service request; the fifth module transmits the data message to the relay device such that the relay device forwards the data message to the user equipment.

Here, the paging request device includes, but not limited to, for example, MSC, VLR, SMS-GMSC, SC, etc., i.e., any device that may send a paging message to the user equipment via MME may act as the paging request device; the paging message includes, but not limited to, a paging message that may be forwarded and processed by the mobility management entity such as SMS.

After the attach procedure through the D2D relay is completed, the mobility management entity obtains a relay device corresponding to the user equipment based on the obtained identification information of the user equipment in the paging message, for example, by retrieving a mapping relationship between user equipments and relay devices stored in the mobility management entity, so as to directly transmit the paging message and a service request corresponding to the paging request to the relay device, rather than to the user equipment; then, the service request is transmitted to the paging request device, e.g., MSC; finally, based on the data message transmitted from the paging request device, the data message is transmitted to the relay device in a certain manner, e.g., NAS packaged, for being forwarded.

In the detach procedure:

The first request obtaining module 11 obtains a detach request transmitted by a relay device, wherein the detach request includes identification information of the relay device, and identification information of one or more user equipments corresponding to the attach request.

Specifically, if the attach procedure based on D2D relay has been completed, the user equipment directly transmits a detach request including the identification information of the user equipment and the identification information of the relay device to the relay device, and the relay device forwards the detach request to the base station.

If the attach procedure of the user equipment is not based on the D2D relay-based attach procedure in the present invention, it is similar to the attach procedure. The user equipment may initiatively transmit a request to the relay device so as to obtain identification information of the relay device which is transmitted by the relay device; or, the relay device may initiatively notify its identification information to the user equipment. Therefore, the user equipment may generate an detach request including the identification information of the user equipment and the identification information of the relay device, and transmit the detach request to the relay device; then, the relay device forwards the detach request to the base station.

Or, the user equipment may establish a correspondence relationship with the relay device through a registration procedure; then, the user equipment transmits a detach request including the identification information of the user equipment to the relay device; the relay device, after adding its own identification information to the detach request, sends the detach request to the base station.

Here, trigger of the detach request is for example, the connection between the user equipment and the relay device is lost.

The first request transmitting module 12 forwards the detach request to a mobility management entity corresponding to the base station; correspondingly, the second request obtaining module 21 obtains the detach request transmitted by the base station corresponding to the mobility management entity, wherein the detach request includes identification information of the relay device, and identification information of one or more user equipments corresponding to the attach request.

Specifically, the first request transmitting module 12 identifies that the detach request is a D2D relay detach request based on the identification information of the relay device in the detach request; and forwards the detach request to the mobility management entity corresponding to the base station.

The location updating module 22 updates location information corresponding to the user equipment.

Specifically, the location updating module 22 deletes the location information of the user equipment from the current mobility management entity based on the detach request, i.e., the user equipment is not associated with the current mobility management entity any more.

The second acceptance transmitting module 23 transmits a detach acceptance message to the base station, wherein the detach acceptance message corresponds to the detach request. Correspondingly, the first acceptance obtaining module 13 obtains the detach acceptance message transmitted by the mobility management entity.

Specifically, when all of the above relevant processes are completed, the second acceptance transmitting module 23 will transmit a detach acceptance message corresponding to the detach request to the base station, the detach acceptance message indicates that the detach request has been accepted, and the user equipment is not associated with the current mobility management entity any more.

The first acceptance transmitting module 14 transmits the detach acceptance message to the relay device, such that the relay device forwards the detach acceptance message to the user equipment.

Preferably, in the detach procedure, the mapping updating module deletes the mapping between identification information of the relay device and identification information of the user equipment, so as to update the mapping relationship between identification information of the relay device and identification information of the user equipment.

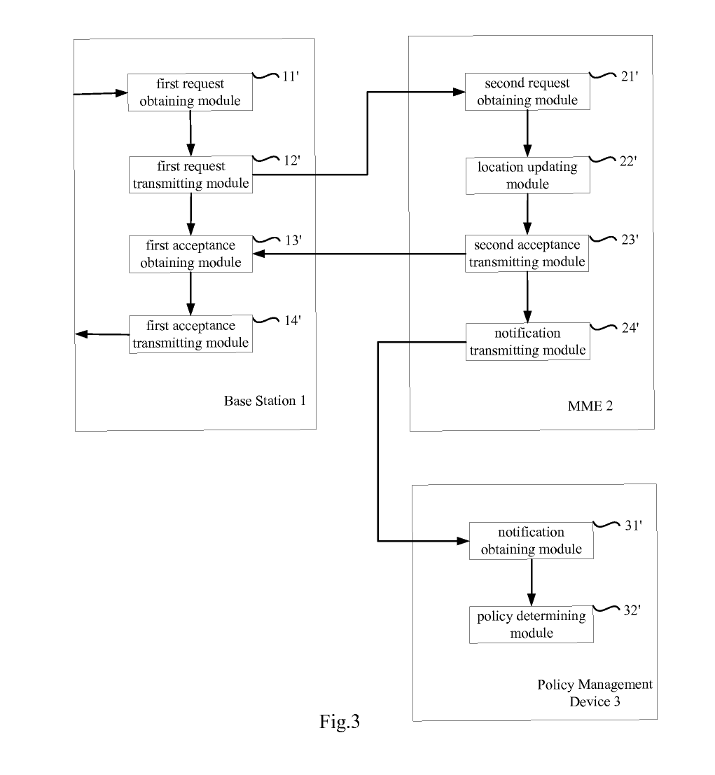

FIG. 3 shows a schematic diagram of a base station, a mobility management entity and a policy management device for D2D relay according to one preferred embodiment of the present invention. Here, the base station 1 comprises a first request obtaining module 11′, a first request transmitting module 12′, a first acceptance obtaining module 13′, a first acceptance transmitting module 14; the mobility management entity 2 comprises a second request obtaining module 21′, a location updating module 22′, a second acceptance transmitting module 23′, a notification transmitting module 24; the policy management device 3 comprises a notification obtaining module 31′, a policy determining module 32′.

Specifically, the first request obtaining module 11′ obtains an attach request/detach request transmitted by a relay device, wherein the attach request/detach request includes identification information of the relay device, and identification information of one or more user equipments corresponding to the attach request/detach request; the first request transmitting module 12′ forwards the attach request/detach request to a mobility management entity corresponding to the base station; correspondingly, the second request obtaining module 21′ obtains the attach request/detach request transmitted by the base station corresponding to the mobility management entity, wherein the attach request/detach request includes identification information of the relay device, and identification information of one or more user equipments corresponding to the attach request/detach request; the location updating module 22′ updates location information corresponding to the user equipment; the second acceptance transmitting module 23′ transmits an attach acceptance message/detach acceptance message to the base station, wherein the attach acceptance message corresponds to the attach request, the detach acceptance message corresponds to the detach request; correspondingly, the first acceptance obtaining module 13′ obtains the attach acceptance message/detach acceptance message transmitted by the mobility management entity, wherein the attach acceptance message corresponds to the attach request, the detach acceptance message corresponds to the detach request; the first acceptance transmitting module 14′ transmits the attach acceptance message/detach acceptance message to the relay device, such that the relay device forwards the attach acceptance message/detach acceptance message to the user equipment; the notification transmitting module 24′ transmits a change notification message to a policy management device, wherein the change notification message includes attach status information of the user equipment and identification information of the user equipment; correspondingly, the notification obtaining module 31′ obtains the change notification message transmitted by the mobility management entity corresponding to the policy management device, wherein the change notification message includes attach status information of the user equipment and the identification information of the user equipment; the policy determining module 32′ determines policy information associated with the user equipment based on the change notification message.

Herein, the first request obtaining module 11′, the first request transmitting module 12′, the first acceptance obtaining module 13′, the first acceptance transmitting module 14′ of the base station 1, the second request obtaining module 21′, the location updating module 22′, the second acceptance transmitting module 23′ of the mobility management entity 2 are identical or substantially identical to corresponding modules shown in FIG. 2, which are thus not detailed here, but incorporated here by reference.

The notification transmitting module 24′ transmits a change notification message to the policy management device, wherein the change notification message includes attach status information of the user equipment and identification information of the user equipment; correspondingly, the notification obtaining module 31′ obtains the change notification message transmitted by the mobility management entity corresponding to the policy management device.

Specifically, if the user equipment has been attached to the mobility management entity, then the attach status information includes one or more kinds of information such as the current attach status (already attached) of the user equipment, attach object (e.g., the current mobility management entity), the relay device; if the user equipment has been detached from the mobility management entity, then the attach status information includes information notifying that the user equipment has already not been associated with the mobility management entity.

The notification transmitting module 24′ transmits the change notification message including the attach status information and the identification information of the user equipment to the policy management device, such that the policy management device knows that the user equipment has been attached to the network through a relay device, or detached.

The policy determining module 32′ determines policy information associated with the user equipment based on the change notification message.

Specifically, the policy determining module 32′ determines policy information associated with the user equipment based on the change notification message in accordance with input information (e.g., user equipment service configuration information in the Subscription Profile Repository) saved in various kinds of devices, e.g., SPR, OCS, or service provider, or other input from the network, wherein the policy information includes, but not limited to, bearer information of the user equipment, or preferably, may also include a routing/service chaining policy for the data flow of the user equipment.

Preferably, when the change notification message corresponds to a plurality of user equipments, and moreover when the plurality of user equipments correspond to the same group (such as D2D-LAN), the policy management device 3 may identify the number of the group, and generate the corresponding policy for the group. Specifically, the policy management device 3 further comprises at least one of the following:

a main device determining module (not shown): the main device determining module determines a main user equipment for the group from among the plurality of user equipments based on random selection or a predefined selection manner. For example, each user equipment will be assigned a rank indication. Once the group is detected by the policy management device, the member with highest rank will be selected as the main user equipment. The service of the main user equipment will apply to whole group.

Here, other manners of determining a main user equipment based on the user equipment's network bandwidth and available resource are likewise applicable for the present invention; those skilled in the art should understand that other similar determining manners are likewise applicable for the present invention and likewise included within the protection scope of the present invention, which are incorporated here by reference.

a configuration determining module (not shown): the configuration determining module determines configuration information for the group. Here, the configuration determining module may match, based on prestored various kinds of candidate configuration information, the condition of the current group with the condition corresponding to the candidate configuration information; if the match succeeds, the candidate configuration information is used as the configuration information of the group. For example, based on the mandatory members for a group. If the members of the group meet the criteria, the service/policy for this group will apply.

Here, the new D2D rank indication and D2D-LAN profile can be saved in either local database in related NE (e.g. PCRF) or global database like HSS.

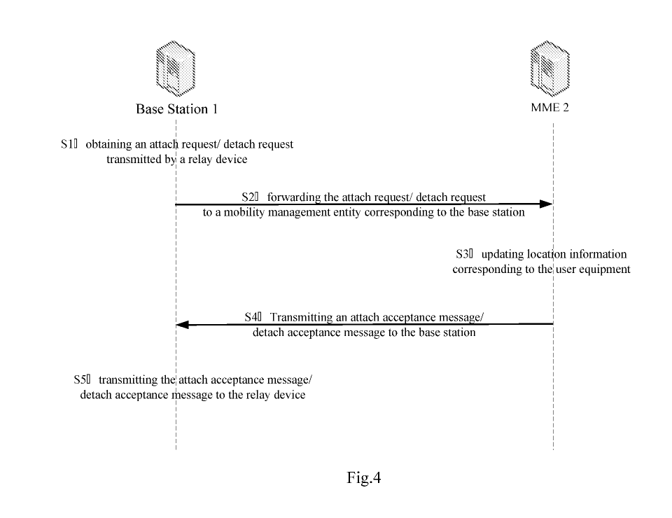

FIG. 4 shows a flow diagram of a method for D2D relay by cooperation of a base station and a mobility management entity according to one aspect of the present invention.

Specifically, in the step S1, the base station 1 obtains an attach request/detach request transmitted by a relay device, wherein the attach request/detach request includes identification information of the relay device, and identification information of one or more user equipments corresponding to the attach request/detach request; in the step S2, the base station 1 forwards the attach request/detach request to a mobility management entity corresponding to the base station; correspondingly, in the step S2, the mobility management entity 2 obtains the attach request/detach request transmitted by the base station corresponding to the mobility management entity, wherein the attach request/detach request includes identification information of the relay device, and identification information of one or more user equipments corresponding to the attach request/detach request; in the step S3, the mobility management entity 2 updates location information corresponding to the user equipment; in the step S4, the mobility management entity 2 transmits an attach acceptance message/detach acceptance message to the base station, wherein the attach acceptance message corresponds to the attach request, the detach acceptance message corresponds to the detach request; correspondingly, in the step S4, the base station 1 obtains the attach acceptance message/detach acceptance message transmitted by the mobility management entity, wherein the attach acceptance message corresponds to the attach request, the detach acceptance message corresponds to the detach request; in the step S5, the base station 1 transmits the attach acceptance message/detach acceptance message to the relay device, such that the relay device forwards the attach acceptance message/detach acceptance message to the user equipment.

Here, the base station and the mobility management entity may perform an attach procedure to the user equipment first through the D2D relay, and then perform a detach procedure to the user equipment; they may also perform a detach procedure to the attached user equipment directly through the D2D relay, without considering whether the attach procedure of the user equipment has gone through the D2D relay.

Hereinafter, explanations will be illustrated through an attach procedure and a detach procedure respectively:

In the attach procedure:

In the step S1, the base station 1 obtains an attach request transmitted by a relay device, wherein the attach request includes identification information of the relay device, and identification information of one or more user equipments corresponding to the attach request.

Specifically, the user equipment may initiatively transmit a request to the relay device so as to obtain identification information of the relay device which is transmitted by the relay device; or, the relay device may initiatively notify its identification information to the user equipment. Therefore, the user equipment may generate an attach request including the identification information of the user equipment and the identification information of the relay device, and transmit the attach request to the relay device; then, the relay device forwards the attach request to a base station.

Or, the user equipment may establish a correspondence relationship with the relay device through a registration procedure; then, the user equipment transmits an attach request including the identification information of the user equipment to the relay device; the relay device, after adding its own identification information to the attach request, sends the attach request to the base station.

Here, the identification information of the user equipment or the identification information of the relay device includes, but not limited to, various kinds of identification codes such as IMSI.

Here, if the attach request or detach request corresponds to a plurality of user equipments, then the plurality of user equipments may transmit the user identification information to the relay device, respectively; a D2D-LAN may also be formed, where a plurality of user equipments share the same D2D-LAN identification information; through the replay device's processing to the D2D-LAN identification information, processing of the plurality of user equipments is realized.

In the step S2, the base station 1 forwards the attach request to a mobility management entity corresponding to the base station; correspondingly, in the step S2, the mobility management entity 2 obtains the attach request transmitted by the base station corresponding to the mobility management entity, wherein the attach request includes identification information of the relay device, and identification information of one or more user equipments corresponding to the attach request.

Specifically, in the step S2, the base station 1 identifies that the attach request is a D2D relay attach request based on the identification information of the relay device in the attach request; and forwards the attach request to the mobility management entity corresponding to the base station. Since the user equipment will share the bearer with the relay device, bearer creation operation will be ignored in the attach procedure.

In the step S3, the mobility management entity 2 updates location information corresponding to the user equipment.

Specifically, in the step S3, the mobility management entity 2 updates the location information of the user equipment to location information corresponding to the current mobility management entity based on the attach request.

Preferably, the method further comprises a step S8 (not shown); if an initial session exists between the user equipment and an initial mobility management entity, then in the step S8, the mobility management entity 2 will delete the initial session such that the mobility management entity 2 updates the location information of the user equipment from the initial mobility management entity to the current mobility management entity.

Preferably, the method further comprises a step S9 (not shown); n the step S9, the mobility management entity 2 updates, based on the attach request, a mapping relationship between identification information of the relay device and identification information of the user equipment.

Specifically, in the attach procedure, if the user equipment does not establish a mapping with any relay device, then the updating operation is a storing operation; if the user equipment has established a mapping with other relay device, then the original mapping is deleted, and the current mapping is stored for further signaling communication routing and the policy and service control.

In the step S4, the mobility management entity 2 transmits an attach acceptance message to the base station, wherein the attach acceptance message corresponds to the attach request. Correspondingly, in the step S4, the base station 1 obtains the attach acceptance message transmitted by the mobility management entity.

Specifically, when all of the above relevant processes are completed, in the step S4, the mobility management entity 2 will transmit an attach acceptance message corresponding to the attach request to the base station, the attach acceptance message indicates that the attach request has been accepted.

In the step S5, the base station 1 transmits the attach acceptance message to the relay device, such that the relay device forwards the attach acceptance message to the user equipment.

Preferably, after the attach procedure is completed, a device such as the mobility management entity may also process various kinds of paging messages to the user equipment, e.g., a short messaging service message (SMS), etc.

Specifically, the mobility management entity obtains one or more paging messages to the user equipment which are transmitted by a paging request device, wherein the paging message includes identification information of the user equipment; transmits a paging request and a service request to the relay device corresponding to the user equipment based on identification information of the user equipment; transmits the service request to the paging request device; obtains a data message transmitted by the paging request device, wherein the data message corresponds to the service request; transmits the data message to the relay device such that the relay device forwards the data message to the user equipment.

Here, the paging request device includes, but not limited to, for example, MSC, VLR, SMS-GMSC, SC, etc., i.e., any device that may send a paging message to the user equipment via MME may act as the paging request device; the paging message includes, but not limited to, a paging message that may be forwarded and processed by the mobility management entity such as SMS.

After the attach procedure through the D2D relay is completed, the mobility management entity obtains a relay device corresponding to the user equipment based on the obtained identification information of the user equipment in the paging message, for example, by retrieving a mapping relationship between user equipments and relay devices stored in the mobility management entity, so as to directly transmit the paging message and a service request corresponding to the paging request to the relay device, rather than to the user equipment; then, the service request is transmitted to the paging request device, e.g., MSC; finally, based on the data message transmitted from the paging request device, the data message is transmitted to the relay device in a certain manner, e.g., NAS packaged, for being forwarded.

In the detach procedure:

In the step S1, the base station obtains a detach request transmitted by a relay device, wherein the detach request includes identification information of the relay device, and identification information of one or more user equipments corresponding to the attach request.

Specifically, if the attach procedure based on D2D relay has been completed, the user equipment directly transmits a detach request including the identification information of the user equipment and the identification information of the relay device to the relay device, and the relay device forwards the detach request to the base station.

If the attach procedure of the user equipment is not based on the D2D relay-based attach procedure in the present invention, it is similar to the attach procedure. The user equipment may initiatively transmit a request to the relay device so as to obtain identification information of the relay device which is transmitted by the relay device; or, the relay device may initiatively notify its identification information to the user equipment. Therefore, the user equipment may generate an detach request including the identification information of the user equipment and the identification information of the relay device, and transmit the detach request to the relay device; then, the relay device forwards the detach request to the base station.

Or, the user equipment may establish a correspondence relationship with the relay device through a registration procedure; then, the user equipment transmits a detach request including the identification information of the user equipment to the relay device; the relay device, after adding its own identification information to the detach request, sends the detach request to the base station.

Here, trigger of the detach request is for example, the connection between the user equipment and the relay device is lost.

In the step S2, the base station 1 forwards the detach request to a mobility management entity corresponding to the base station; correspondingly, in the step S2, the mobility management entity 2 obtains the detach request transmitted by the base station corresponding to the mobility management entity, wherein the detach request includes identification information of the relay device, and identification information of one or more user equipments corresponding to the attach request.

Specifically, in the step S2, the base station 1 identifies that the detach request is a D2D relay detach request based on the identification information of the relay device in the detach request; and forwards the detach request to the mobility management entity corresponding to the base station.

In the step S3, the mobility management entity 2 updates location information corresponding to the user equipment.

Specifically, in the step S3, the mobility management entity 2 deletes the location information of the user equipment from the current mobility management entity based on the detach request, i.e., the user equipment is not associated with the current mobility management entity any more.

In the step S4, the mobility management entity 2 transmits a detach acceptance message to the base station, wherein the detach acceptance message corresponds to the detach request. Correspondingly, in the step S3, the base station 1 obtains the detach acceptance message transmitted by the mobility management entity.

Specifically, when all of the above relevant processes are completed, in the step S4, the mobility management entity 2 will transmit a detach acceptance message corresponding to the detach request to the base station, the detach acceptance message indicates that the detach request has been accepted, and the user equipment is not associated with the current mobility management entity any more.

In the step S5, the base station 1 transmits the detach acceptance message to the relay device, such that the relay device forwards the detach acceptance message to the user equipment.

Preferably, in the detach procedure, the mobility management entity 2 deletes the mapping between identification information of the relay device and identification information of the user equipment, so as to update the mapping relationship between identification information of the relay device and identification information of the user equipment.

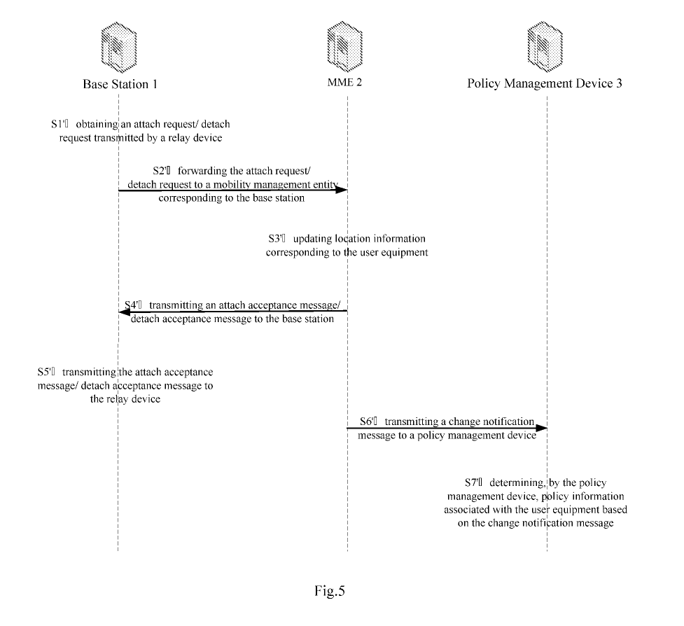

FIG. 5 shows a flow diagram of a method for D2D relay by cooperation of a base station, a mobility management entity and a policy management device according to one preferred embodiment of the present invention.

Specifically, in the step S1′, the base station 1 obtains an attach request/detach request transmitted by a relay device, wherein the attach request/detach request includes identification information of the relay device, and identification information of one or more user equipments corresponding to the attach request/detach request; in the step S2′, the base station 1 forwards the attach request/detach request to a mobility management entity corresponding to the base station; correspondingly, in the step S2′, the mobility management entity 2 obtains the attach request/detach request transmitted by the base station corresponding to the mobility management entity, wherein the attach request/detach request includes identification information of the relay device, and identification information of one or more user equipments corresponding to the attach request/detach request; in the step S3′, the mobility management entity 2 updates location information corresponding to the user equipment; in the step S4′, the mobility management entity 2 transmits an attach acceptance message/detach acceptance message to the base station, wherein the attach acceptance message corresponds to the attach request, the detach acceptance message corresponds to the detach request; correspondingly, in the step S4′, the base station 1 obtains the attach acceptance message/detach acceptance message transmitted by the mobility management entity, wherein the attach acceptance message corresponds to the attach request, the detach acceptance message corresponds to the detach request; in the step S5′, the base station 1 transmits the attach acceptance message/detach acceptance message to the relay device, such that the relay device forwards the attach acceptance message/detach acceptance message to the user equipment; in the step S6′, the mobility management entity 2 transmits a change notification message to a policy management device, wherein the change notification message includes attach status information of the user equipment and identification information of the user equipment; correspondingly, in the step S6′, the policy management device 3 obtains the change notification message transmitted by the mobility management entity corresponding to the policy management device, wherein the change notification message includes attach status information of the user equipment and the identification information of the user equipment; in the step S7′, the policy management device 3 determines policy information associated with the user equipment based on the change notification message.

Herein, the step S1′, the step S2′, the step S3′, the step S4′, the step S5′ are identical or substantially identical to corresponding steps shown in FIG. 4, which are thus not detailed here, but incorporated here by reference.

In the step S6′, the mobility management entity 2 transmits a change notification message to the policy management device, wherein the change notification message includes attach status information of the user equipment and identification information of the user equipment; correspondingly, in the step S6′, the policy management device 3 obtains the change notification message transmitted by the mobility management entity corresponding to the policy management device.

Specifically, if the user equipment has been attached to the mobility management entity, then the attach status information includes one or more kinds of information such as the current attach status (already attached) of the user equipment, attach object (e.g., the current mobility management entity), the relay device; if the user equipment has been detached from the mobility management entity, then the attach status information includes information notifying that the user equipment has already not been associated with the mobility management entity.

In the step S6′, the mobility management entity 2 transmits the change notification message including the attach status information and the identification information of the user equipment to the policy management device, such that the policy management device knows that the user equipment has been attached to the network through a relay device, or detached.

In the step S7′, the policy management device 3 determines policy information associated with the user equipment based on the change notification message.

Specifically, in the step S7′, the policy management device 3 determines policy information associated with the user equipment based on the change notification message in accordance with input information (e.g., user equipment service configuration information in the Subscription Profile Repository) saved in various kinds of devices, e.g., SPR, OCS, or service provider, or other input from the network, wherein the policy information includes, but not limited to, bearer information of the user equipment, or preferably, may also include a routing/service chaining policy for the data flow of the user equipment.

Preferably, when the change notification message corresponds to a plurality of user equipments, and moreover when the plurality of user equipments correspond to the same group (such as D2D-LAN), the policy management device 3 may identify the number of the group, and generate the corresponding policy for the group. Specifically, the policy management device 3 further comprises at least one of the following steps:

determining a main user equipment for the group from among the plurality of user equipments based on random selection or a predefined selection manner. For example, each user equipment will be assigned a rank indication. Once the group is detected by the policy management device, the member with highest rank will be selected as the main user equipment. The service of the main user equipment will apply to whole group.

Here, other manners of determining a main user equipment based on the user equipment's network bandwidth and available resource are likewise applicable for the present invention; those skilled in the art should understand that other similar determining manners are likewise applicable for the present invention and likewise included within the protection scope of the present invention, which are incorporated here by reference.

determining configuration information for the group. Here, the configuration determining module may match, based on prestored various kinds of candidate configuration information, the condition of the current group with the condition corresponding to the candidate configuration information; if the match succeeds, the candidate configuration information is used as the configuration information of the group. For example, based on the mandatory members for a group. If the members of the group meet the criteria, the service/policy for this group will apply.

Here, the new D2D rank indication and D2D-LAN profile can be saved in either local database in related NE (e.g. PCRF) or global database like HSS.

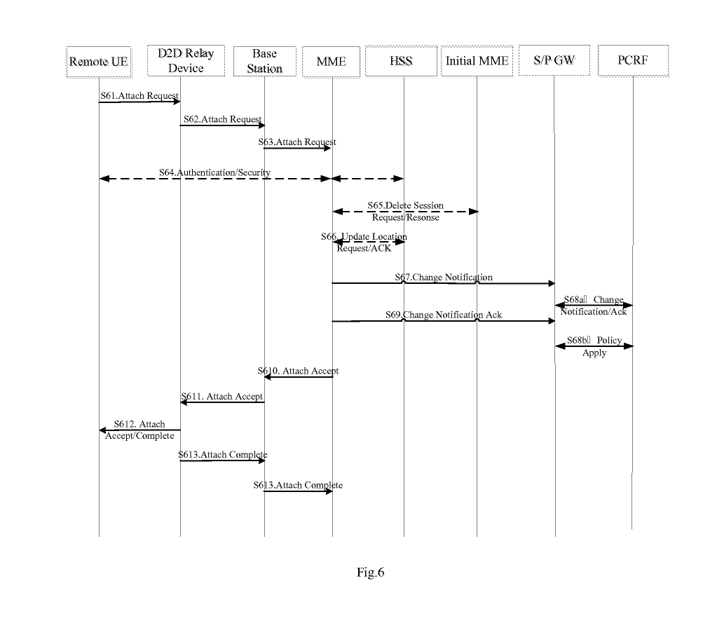

FIG. 6 shows a flow diagram of an attach method for D2D relay according to one preferred embodiment of the present invention.

Here, FIGS. 6, 7, and 8 are all illustrated with a D2D relay method in a LTE system as an example, and those skilled in the art should understand that a D2D relay method in other communication systems, if applicable to the present invention, may likewise be included within the protection scope of the present invention.

In step S61 and step S62, in the attach request, the remote UE initiates the attach procedure to the eNB through D2D relay device with a indicator D2D relay device identifier which include the IMSI of the D2D Relay UE.

In step S63, the eNB will forward the attach request to MME, which is the same as the one forwarded by the D2D relay device.

In step S64 to step S66, MME will check if there is new indicator D2D relay device identifier is received in the attach request, if there is, a simplified attach handling will be initiated by MME, including delete the old session on old MME if there is, update location for remote UE. Since the remote UE will share the bearer with the D2D relay device, bearer creation operation will be ignored in the attach procedure. On MME, it will also maintain a mapping between the ID (IMSI) of the D2D relay device and remote UE for further signaling communication routing and policy/service controlling.

In step S67 to step S69, the D2D relay attach event will be reported to PCRF in PCC. Upon receiving the D2D relay attach notification from MME, PCRF will generate related policy for the remote UE base on the input from SPR, OCS, service provision and other input from network. The policy will be apply to the EPS bearer for the D2D relay and further routing/service chaining for the data flow of this remote UE.

In step S610 to step S613, normal attach and complete messages will be exchanged to finish the attach procedure.

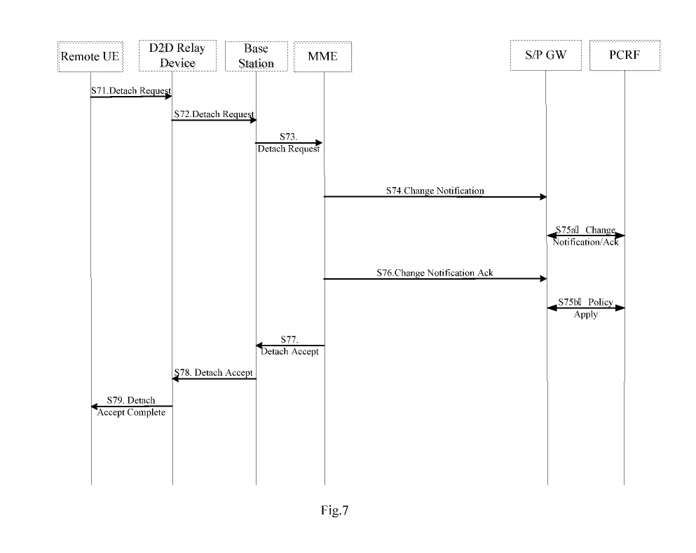

FIG. 7 shows a flow diagram of a detach method for D2D relay according to one preferred embodiment of the present invention.

The detach request can be triggered by either remote UE or the D2D relay device (e.g. the connection between remote UE and D2D relay device is lost) if attach procedure for D2D relay applied already. The indicator D2D relay device identifier which include the IMSI of the D2D relay device need to be added into the detach request to distinguish it from a normal detach message.

In step S71 to step S73, the detach request is send to the MME through the D2D relay device.

On MME, once it receives the detach request for remote UE, it needs to delete the mapping between the ID (i.e. IMSI) of the D2D relay device and remote UE. If needed, MME can update the HSS about the status of remote UE, i.e. un-available.

In step S74 to step S76, similar notification will be sent to PCRF for further policy modification for the bearer and related routing/service chaining.

In step S77 to step S79, a detach acceptance message is sent to the remote UE through a D2D relay device, thereby completing the detach procedure.

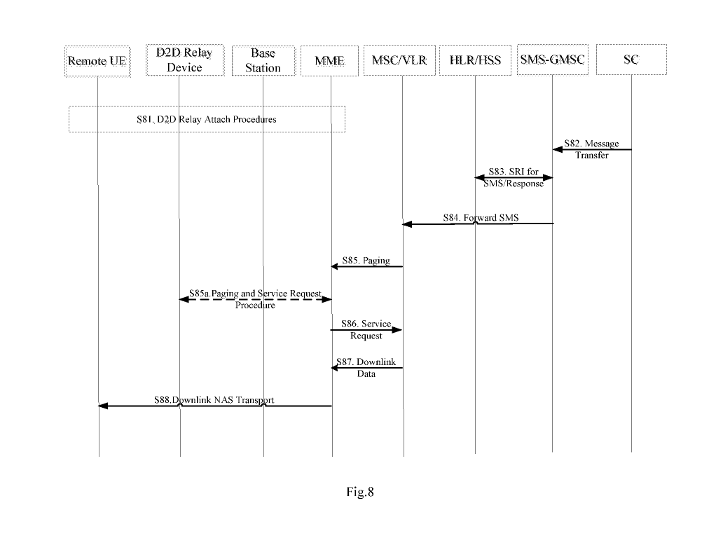

FIG. 8 shows a flow diagram of a method for a mobile terminating short messaging service for a remote UE using D2D relay according to one preferred embodiment of the present invention.

In step S81, the attach procedure for signaling communication via D2D relay for remote UE applied already.

In step S82 to step S85, as defined by 3GPP 23.272, normal mobile terminating SMS from SC to MME is implemented. In ordinary situations, in the Paging (IMSI, VLR TMSI, Location Information, SMS indicator) message to the MME, the IMSI is for remote UE.

In step S86, the MME will retrieve the IMSI of D2D relay device base on remote UE's IMSI received in the paging. If the D2D relay device is in idle mode, the MME initiates the paging procedure by sending the paging to the relay device and triggers the service request of UE, and then, sends a service request message to the MSC. Otherwise, The MME sends a service request message to the MSC directly.

In step S87, the MSC/VLR builds the SMS message to be sent as defined in TS 23.040. The MSC/VLR forwards the SMS message to the MME in a downlink unit data message.

In step S88, the MME encapsulates the SMS message in a NAS message and sends the message to the remote UE through D2D relay device.

It should be noted that the present invention may be implemented in software and/or a combination of software and hardware, for example, it may be implemented by an application-specific integrated circuit (ASIC) or any other similar hardware device. In one embodiment, the software program of the present invention may be executed through a processor to implement the steps or functions as mentioned above. Likewise, the software program of the present invention (including relevant data structure) may be stored in the computer-readable recording medium, for example, RAM memory, magnetic or optic driver or Happy disk or similar devices. Besides, some steps or functions of the present invention may be implemented by hardware, for example, as a circuit cooperating with the processor to execute various steps or functions.

To those skilled in the art, it is apparent that the present invention is not limited to the details of above exemplary embodiments, and the present invention can be implemented with other specific embodiments without departing the spirit or basic features of the present invention. Thus, from any perspective, the embodiments should be regarded as illustrative and non-limiting. The scope of the present invention is limited by the appended claims, instead of the above description. Thus, meanings of equivalent elements falling within the claims and all variations within the scope are intended to be included within the present invention. Any reference numerals in the claims should not be regarded as limiting the involved claims. Besides, it is apparent that such terms as “comprise” and “include” do not exclude other units or steps, and a single form does not exclude a plural form. The multiple units or modules as stated in system or apparatus claims can also be implemented by a single unit or module through software or hardware. Terms such as first and second are used to represent names, not representing any specific sequence.

While example embodiments have been particularly shown and described, it will be understood by those skilled in the art that variations in form and detail may be made therein without departing from the spirit and scope of the claims. The protection sought herein is as set forth in the appended claims. Those and other aspects of various embodiments are specified in the following numbered clauses:

1. A method for D2D relay in a base station, wherein the method comprises:

obtaining an attach request/detach request transmitted by a relay device, wherein the attach request/detach request includes identification information of the relay device, and identification information of one or more user equipments corresponding to the attach request/detach request;

forwarding the attach request/detach request to a mobility management entity corresponding to the base station;

wherein the method further comprises:

obtaining an attach acceptance message/detach acceptance message transmitted by the mobility management entity, wherein the attach acceptance message corresponds to the attach request, the detach acceptance message corresponds to the detach request;

transmitting the attach acceptance message/detach acceptance message to the relay device, such that the relay device forwards the attach acceptance message/detach acceptance message to the user equipment.

2. A method for D2D relay in a mobility management entity, wherein the method comprises:

obtaining an attach request/detach request transmitted by a base station corresponding to the mobility management entity, wherein the attach request/detach request includes identification information of the relay device, and identification information of one or more user equipments corresponding to the attach request/detach request;

updating location information corresponding to the user equipment;

wherein the method further comprises:

transmitting an attach acceptance message/detach acceptance message to the base station, wherein the attach acceptance message corresponds to the attach request, the detach acceptance message corresponds to the detach request.

3. The method according to clause 2, wherein when obtaining an attach request transmitted by a base station corresponding to the mobility management entity, the method further comprises:

deleting an initial session if the initial session exists between the user equipment and an initial mobility management entity.

4. The method according to clause 2 or 3, wherein the method further comprises:

updating, based on the attach request/detach request, a mapping relationship between identification information of the relay device and identification information of the user equipment.

5. The method according to any one of clauses 2-4, wherein the method further comprises:

transmitting a change notification message to a policy management device, wherein the change notification message includes attach status information of the user equipment and identification information of the user equipment.

6. The method according to any one of clauses 2-5, wherein when the attach acceptance message has been transmitted to the base station, the method further comprises:

obtaining one or more paging messages to the user equipment which are transmitted by a paging request device, wherein the paging message includes identification information of the user equipment;

transmitting a paging request and a service request to the relay device corresponding to the user equipment based on identification information of the user equipment;

transmitting the service request to the paging request device;

obtaining a data message transmitted by the paging request device, wherein the data message corresponds to the service request;

transmitting the data message to the relay device such that the relay device forwards the data message to the user equipment.

7. A method for D2D relay in a policy management device, wherein the method comprises:

obtaining a change notification message transmitted by a mobility management entity corresponding to the policy management device, wherein the change notification message includes attach status information of the user equipment and the identification information of the user equipment;

determining policy information associated with the user equipment based on the change notification message.

8. The method according to clause 7, wherein when the change notification message corresponds to a plurality of user equipments, and moreover when the plurality of user equipments correspond to the same group, the method further comprises at least one of the following:

determining a main user equipment for the group from among the plurality of user equipments;

determining configuration information for the group.

9. A method for D2D relay in a relay device, wherein the method comprises:

obtaining an attach request/detach request transmitted by a user equipment, wherein the attach request/detach request includes identification information of the relay device, and identification information of the user equipment;

transmitting the attach request/detach request to a base station, wherein the base station corresponds to the relay device;

wherein the method further comprises:

obtaining an attach acceptance message/detach acceptance message transmitted by the base station, wherein the attach acceptance message corresponds to the attach request, the detach acceptance message corresponds to the detach request;

forwarding the attach acceptance message/detach acceptance message to the user equipment.

10. A base station for D2D relay, wherein the base station comprises:

a first request obtaining module configured to obtain an attach request/detach request transmitted by a relay device, wherein the attach request/detach request includes identification information of the relay device, and identification information of one or more user equipments corresponding to the attach request/detach request;

a first request transmitting module configured to forward the attach request/detach request to a mobility management entity corresponding to the base station;

wherein the base station further comprises:

a first acceptance obtaining module configured to obtain an attach acceptance message/detach acceptance message transmitted by the mobility management entity, wherein the attach acceptance message corresponds to the attach request, the detach acceptance message corresponds to the detach request;

a first acceptance transmitting module configured to transmit the attach acceptance message/detach acceptance message to the relay device, such that the relay device forwards the attach acceptance message/detach acceptance message to the user equipment.

11. A mobility management entity for D2D relay, wherein the mobility management entity comprises:

a second request obtaining module configured to obtain an attach request/detach request transmitted by a base station corresponding to the mobility management entity, wherein the attach request/detach request includes identification information of the relay device, and identification information of one or more user equipments corresponding to the attach request/detach request;

a location updating module configured to update location information corresponding to the user equipment;

wherein the mobility management entity further comprises:

a second acceptance transmitting module configured to transmit an attach acceptance message/detach acceptance message to the base station, wherein the attach acceptance message corresponds to the attach request, the detach acceptance message corresponds to the detach request.

12. The mobility management entity according to clause 11, wherein when obtaining an attach request transmitted by a base station corresponding to the mobility management entity, the mobility management entity further comprises:

a session deleting module configured to delete an initial session if the initial session exists between the user equipment and an initial mobility management entity.

13. The mobility management entity according to clause 11 or 12, wherein the mobility management entity further comprises:

a mapping updating module configured to update, based on the attach request/detach request, a mapping relationship between identification information of the relay device and identification information of the user equipment.

14. The mobility management entity according to any one of clauses 11-13 wherein the mobility management entity further comprises:

a notification transmitting module configured to transmit a change notification message to a policy management device, wherein the change notification message includes attach status information of the user equipment and identification information of the user equipment.

15. The mobility management entity according to any one of clauses 11-14, wherein the mobility management entity further comprises:

a first module configured to obtain one or more paging messages to the user equipment which are transmitted by a paging request device, wherein the paging message includes identification information of the user equipment;

a second module configured to transmit a paging request and a service request to the relay device corresponding to the user equipment based on identification information of the user equipment;

a third module configured to transmit the service request to the paging request device;

a fourth module configured to obtain a data message transmitted by the paging request device, wherein the data message corresponds to the service request;

a fifth module configured to transmit the data message to the relay device such that the relay device forwards the data message to the user equipment.

16. A policy management device for D2D relay, wherein the device comprises:

a notification obtaining module configured to obtain a change notification message transmitted by a mobility management entity corresponding to the policy management device, wherein the change notification message includes attach status information of the user equipment and the identification information of the user equipment;

a policy determining module configured to determine policy information associated with the user equipment based on the change notification message.

17. The policy management device according to clause 16, wherein when the change notification message corresponds to a plurality of user equipments, and moreover when the plurality of user equipments correspond to the same group, the device further comprises at least one of the following:

a main device determining module configured to determine a main user equipment for the group from among the plurality of user equipments;

a configuration determining module configured to determine configuration information for the group.

18. A relay device for D2D relay, wherein the device comprises:

a third request obtaining module configured to obtain an attach request/detach request transmitted by a user equipment, wherein the attach request/detach request includes identification information of the relay device, and identification information of the user equipment;

a second request transmitting module configured to transmit the attach request/detach request to a base station, wherein the base station corresponds to the relay device;

wherein the device further comprises:

a second acceptance obtaining module configured to obtain an attach acceptance message/detach acceptance message transmitted by the base station, wherein the attach acceptance message corresponds to the attach request, the detach acceptance message corresponds to the detach request;

a third acceptance transmitting module configured to forward the attach acceptance message/detach acceptance message to the user equipment

19. A system for D2D relay, wherein the system comprises the base station according to clause 10, the mobility management entity according to any one of clauses 11-15, and the policy management device according to clause 16 or 17.

20. The system according to clause 19, wherein, the system further comprises the relay device according to clause 18.

### LIST OF ABBREVIATIONS IN THE DESCRIPTION AND DRAWINGS

| | |
|---|---|
| AF | Application Function |
| D2D | Device-to-Device |
| EPS | Evolved Packet System |
| G5 | 5th Generation Mobile Communication |
| GMSC | Gateway Mobile Switching Center |
| IMSI | International Mobile Subscriber Identification Number |
| IP | Internet Protocol |
| HSS | Home Subscriber Server |
| HLR | Home Location Register |
| MME | Mobility Management Entity |
| MSC | Mobile Switching Center |
| MTC | Machine-Type Communications |
| OCS | Online Charging System |
| OFCS | Offline Charging System |
| PCC | Policy Control and Charging |
| PCRF | Policy and Charging Rules Function |
| PGW | Public Data Network GateWay |
| SC | Switching Center |
| SGW | Serving GateWay |
| SMS | Short Message Service |
| SPR | Subscription Profile Repository |
| TMSI | Temporary Mobile Subscriber Identity |
| VLR | Visitor Location Register |
| UE | User Equipment |

1. A method for D2D relay, wherein the method comprises:
obtaining, by a base station, an attach request/detach request transmitted by a relay device, wherein the attach request/detach request includes identification information of the relay device, and identification information of one or more user equipments corresponding to the attach request/detach request;
forwarding, by the base station, the attach request/detach request to a mobility management entity corresponding to the base station;
updating, by the mobility management entity, location information corresponding to the user equipment;
transmitting, by the mobility management entity, an attach acceptance message/detach acceptance message to the base station, wherein the attach acceptance message corresponds to the attach request, the detach acceptance message corresponds to the detach request;
transmitting, by the base station, the attach acceptance message/detach acceptance message to the relay device, such that the relay device forwards the attach acceptance message/detach acceptance message to the user equipment.

2. The method according to claim 1, wherein when the mobility management entity obtains an attach request transmitted by the base station, the method further comprises:
deleting, by the mobility management entity, an initial session if the initial session exists between the user equipment and an initial mobility management entity.

3. The method according to claim 1, wherein the method further comprises:
updating, by the mobility management entity, a mapping relationship between identification information of the relay device and identification information of the user equipment based on the attach request/detach request.

4. The method according to claim 1, wherein the method further comprises:
transmitting, by the mobility management entity, a change notification message to a policy management device, wherein the change notification message includes attach status information of the user equipment and identification information of the user equipment
determining, by the policy management device, policy information associated with the user equipment based on the change notification message.

5. The method according to claim 4, wherein when the change notification message corresponds to a plurality of user equipments, and moreover when the plurality of user equipments correspond to the same group, the method further comprises at least one of the following:
determining, by the policy management device, a main user equipment for the group from among the plurality of user equipments;
determining, by the policy management device, configuration information for the group.

6. The method according to claim 1, wherein when the relay device has forwarded the attach acceptance message to the user equipment, the method further comprises:
obtaining, by the mobility management entity, one or more paging messages to the user equipment which are transmitted by a paging request device, wherein the paging message includes identification information of the user equipment;
transmitting, by the mobility management entity, a paging request and a service request to the relay device corresponding to the user equipment based on identification information of the user equipment;
transmitting, by the mobility management entity, the service request to the paging request device;
obtaining, by the mobility management entity, a data message transmitted by the paging request device, wherein the data message corresponds to the service request;
transmitting, by the mobility management entity, the data message to the relay device such that the relay device forwards the data message to the user equipment.

7. A base station for D2D relay, wherein the base station comprises:
a first request obtaining module configured to obtain an attach request/detach request transmitted by a relay device, wherein the attach request/detach request includes identification information of the relay device, and identification information of one or more user equipments corresponding to the attach request/detach request;
a first request transmitting module configured to forward the attach request/detach request to a mobility management entity corresponding to the base station;
wherein the base station further comprises:
a first acceptance obtaining module configured to obtain an attach acceptance message/detach acceptance message transmitted by the mobility management entity, wherein the attach acceptance message corresponds to the attach request, the detach acceptance message corresponds to the detach request;
a first acceptance transmitting module configured to transmit the attach acceptance message/detach acceptance message to the relay device, such that the relay device forwards the attach acceptance message/detach acceptance message to the user equipment.

8. A mobility management entity for D2D relay, wherein the mobility management entity comprises:
a second request obtaining module configured to obtain an attach request/detach request transmitted by a base station corresponding to the mobility management entity, wherein the attach request/detach request includes identification information of the relay device, and identification information of one or more user equipments corresponding to the attach request/detach request;
a location updating module configured to update location information corresponding to the user equipment;
wherein the mobility management entity further comprises:
a second acceptance transmitting module configured to transmit an attach acceptance message/detach acceptance message to the base station, wherein the attach acceptance message corresponds to the attach request, the detach acceptance message corresponds to the detach request.

9. The mobility management entity according to claim 8, wherein when obtaining an attach request transmitted by a base station corresponding to the mobility management entity, the mobility management entity further comprises:
a session deleting module configured to delete an initial session if the initial session exists between the user equipment and an initial mobility management entity.

10. The mobility management entity according to claim 8, wherein the mobility management entity further comprises:
a mapping updating module configured to update, based on the attach request/detach request, a mapping relationship between identification information of the relay device and identification information of the user equipment.

11. The mobility management entity according to claim 8, wherein the mobility management entity further comprises:
a notification transmitting module configured to transmit a change notification message to a policy management device, wherein the change notification message includes attach status information of the user equipment and identification information of the user equipment.

12. The mobility management entity according to claim 8, wherein the mobility management entity further comprises:
a first module configured to obtain one or more paging messages to the user equipment which are transmitted by a paging request device, wherein the paging message includes identification information of the user equipment;
a second module configured to transmit a paging request and a service request to the relay device corresponding to the user equipment based on identification information of the user equipment;
a third module configured to transmit the service request to the paging request device;
a fourth module configured to obtain a data message transmitted by the paging request device, wherein the data message corresponds to the service request;
a fifth module configured to transmit the data message to the relay device such that the relay device forwards the data message to the user equipment.

13. A policy management device for D2D relay, wherein the device comprises:
a notification obtaining module configured to obtain a change notification message transmitted by a mobility management entity corresponding to the policy management device, wherein the change notification message includes attach status information of the user equipment and the identification information of the user equipment;
a policy determining module configured to determine policy information associated with the user equipment based on the change notification message.

14. The policy management device according to claim 13, wherein when the change notification message corresponds to a plurality of user equipments, and moreover when the plurality of user equipments correspond to the same group, the device further comprises at least one of the following:
a main device determining module configured to determine a main user equipment for the group from among the plurality of user equipments;
a configuration determining module configured to determine configuration information for the group.

15. A system for D2D relay, wherein the system comprises the base station according to claim 7, a mobility management entity comprising a second request obtaining module configured to obtain an attach request/detach request transmitted by a base station corresponding to the mobility management entity, wherein the attach request/detach request includes identification information of the relay device, and identification information of one or more user equipments corresponding to the attach request/detach request; a location updating module configured to update location information corresponding to the user equipment; and, a second acceptance transmitting module configured to transmit an attach acceptance message/detach acceptance messaqe to the base station, wherein the attach acceptance message corresponds to the attach request, the detach acceptance message corresponds to the detach request, and a policy management device comprising a notification obtaining module configured to obtain a change notification message transmitted by a mobility management entity corresponding to the policy management device, wherein the change notification message includes attach status information of the user equipment and the identification information of the user equipment; and, a policy determining module configured to determine policy information associated with the user equipment based on the change notification message.
